(19) United States
(12) Patent Application Publication
(10) Pub. No.: US 2006/0152779 A1
(43) Pub. Date: Jul. 13, 2006

(54) Security marking

(75) Inventors: Anthony Henry Joseph Fraser, RUTLAND (GB); Stefan Alexander Pijanowski, Northants (GB)

Correspondence Address: DICKSTEIN SHAPIRO MORIN & OSHINSKY LLP, 2101 L Street, NW, Washington, DC, 20037, US

(73) Assignee: DUBOIS LIMITED, NORTHANTS (GB)

(21) Appl. No.: 10/526,390

(22) PCT Filed: Sep. 2, 2003
(86) PCT No.: PCT/GB03/03800

§ 371 Date: Oct. 11, 2005

(30) Foreign Application Priority Data
Sep. 2, 2002 (GB) 0220315.6

(51) Int. Cl. G03H 1/00

(52) U.S. Cl. 359/2; 283/86

(57) ABSTRACT

A container for housing a CD or DVD, which has a plastics film about the exterior with a security marking formed or attached to the film.

This invention relates to a security marking applied to a product and to methods of forming the same.

It is known to apply an eye-catching pattern to products such as toothpaste tubes, bags of sweets and other such products. These patterns may be printed or reflective, holographic or other diffraction markings.

It is also known to apply a security marking in the form of a holographic or other diffractive image to a product, e.g. to a bank note, credit card, a CD or DVD or to a paper cover of a product. A need exists however for an alternative way of marking a product such as a CD or DVD or of increasing the security marking thereof.

According to a first aspect of the present invention, there is provided a container for housing a product such as a CD or DVD, the container having a plastics film about the exterior thereof with a security marking formed on or attached to said film.

Preferably, the security marking comprises a diffractive element, e.g. a hologram. The diffractive element may be in the form of facets of impressions formed in the plastics film. U.S. Pat. No. 5,200,253 describes a method of simultaneously forming a holographic pattern as an integral part of a plastic sheet as it is molded. The facets may reflect or diffract light incident thereon. The facets may be arranged in a random or ordered pattern, and may be used to provide a decorative feature as well as to provide a level of security.

The method of production of such facets depends on the characteristics of the film. They may, for example, be imprinted in the film using a master plate, e.g. made of a metal, such as nickel. The imprinting process may be a cold process or hot process depending on the physical characteristics of the film that is to be imprinted.

Preferably, the security marking comprises a repeating pattern, the repeat length of which is smaller than the dimension of the container about which it is applied.

The security marking may be formed on a strip a length of which is secured to the film.

Preferably, the film is cut from a continuous length or roll of film before or as it is applied to the container.

Preferably, the security marking is applied to the film before or as the film is applied to the container.

Preferably, the film is attached to the container only at opposite edges thereof, e.g. by a weld or strip of adhesive.

The security pattern may be formed on a carrier sheet, e.g. a thin plastics sheet, e.g. of polypropylene. And, preferably, the film is also formed of polypropylene.

In some cases, the security marking may comprise markings in a metallic layer on the carrier sheet.

Prior to application to the film, the metallic layer may be protected by a removable cover sheet.

Preferably, the carrier sheet is secured to the film by a cold melt adhesive or other cold bonding process.

Preferably, the metallic layer is sandwiched between the carrier sheet and the film.

Preferably, the film is already provided on such products, e.g. if the film is transparent it is used to hold a paper sleeve slid between the outer wall of the container and the film (e.g. as in a conventional DVD or video cassette container).

Preferably, the security marking has a width in the range 5-20 mm and is applied around the container adjacent an edge thereof.

Other features of the invention will be apparent from the following description.

The invention will now be further described, merely by way of example, with reference to the accompanying drawings, in which:

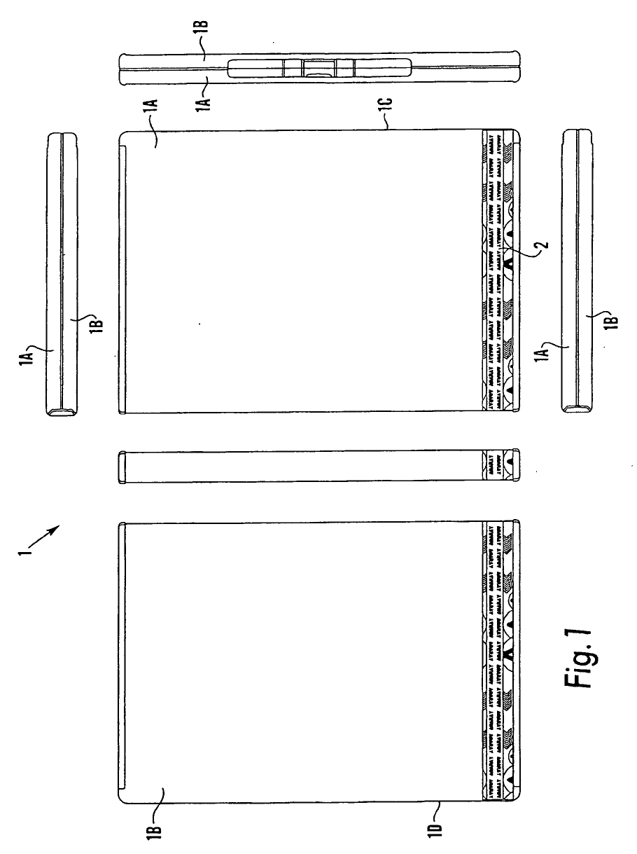

FIG. 1 shows elevations of a DVD container with a preferred embodiment of security strip applied thereto;

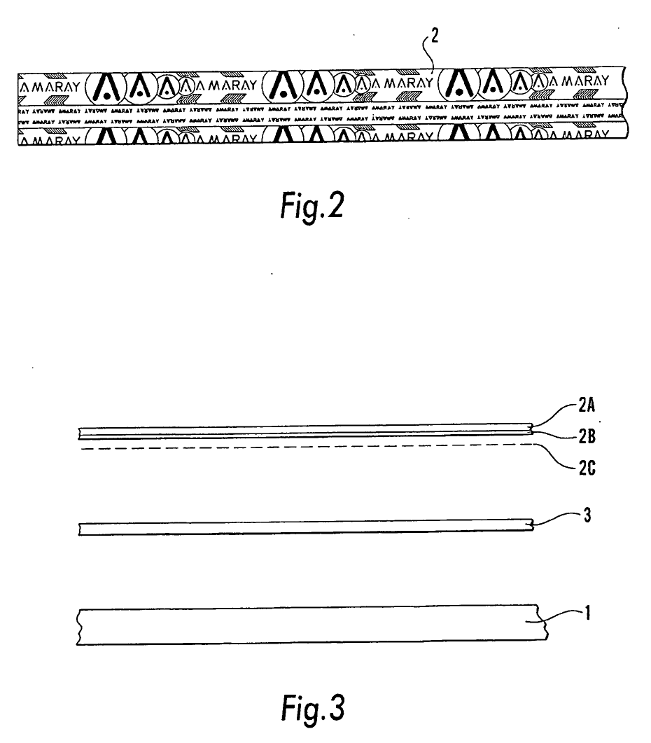

FIG. 2 shows a plan view of another version of a security strip which may be used in place of that shown in FIG. 1;

FIG. 3 is a schematic diagram illustrating how such a security strip may be applied to a film for application to the container.

FIG. 1 shows a conventional DVD container 1 comprising a lid portion 1A and a base portion 1B which are hingedly attached to each other. The container 1 has a plastics film (not shown), e.g. a transparent sheet of polypropylene, around the exterior thereof in the form of a jacket which is attached to the container only along edges 1C and 1D thereof so as to form a sleeve for receiving a paper insert e.g. bearing details of the film or other contents of the DVD housed within the container 1. FIG. 1 also shows a security marking in the form of a holographic strip 2 applied around the bottom edge of the container 1, e.g. across the front cover 1A, around the spine and across the back cover 1B.

FIG. 2 shows a plan view of another form of holographic security strip 3 which may be used in place of that shown in FIG. 1.

FIG. 3 is a schematic view illustrating the form and application of such a strip to such a container. The security strip 2 comprises a plastics carrier sheet 2A, a metallic layer 2B in which the security markings are formed and, optionally, a protective cover sheet 2C (shown detached).

Once the cover sheet 2C has been removed, the security strip 2 is applied to a plastic film 3 which is to form a jacket around the container 1 so that the metallic layer 2B is sandwiched between the carrier sheet 2A and the film 3.

Alternatively, as discussed above, it is possible to form impressions directly into the film, either as the film is molded or as impressions in an existing film.

The application of security markings as described above is relatively inexpensive, e.g. compared to the application of such markings as discrete labels onto a product, e.g. onto a credit card.

1. A container comprising a plastics film attached to the exterior thereof; the plastics film comprising a security marking formed on or attached thereto.

2. A container according to claim 1, wherein the security marking comprises a diffractive element.

3. A container according to claim 1, wherein the security marking comprises a repeating pattern.

4. A container according to claim 3, wherein the security marking comprises a repeating pattern, the repeat length of which is smaller than the dimension of the container about which it is applied.

5. A container according to claim 1, wherein the security marking is in the form of a strip.

6. A container according to claim 5 wherein the strip has a width in the range of 5-20 mm.

7. A container according to claim 5, wherein the strip is formed on a carrier sheet.

8. A container according to claim 7, wherein the carrier sheet is a plastics sheet.

9. A container according to claim 7, wherein the security markings comprises markings in a metallic layer on the carrier sheet.

10. A container according to claim 9, wherein the metallic layer is covered by a removable cover sheet.

11. A container according to claim 7, wherein the carrier sheet is secured to the film by a bonding process.

12. A container according to claim 11, wherein the bonding process is a cold melt adhesive process.

13. A container according to claim 9, wherein the metallic layer is sandwiched between the carrier sheet and the film.

14. A container according to claim 13, wherein the film is a transparent film.

15. A container according to claim 14, wherein the film is for holding a paper sleeve slid between an outer wall of the container and the film.

16. A container according to claim 15 wherein the container is for housing a CD or DVD.

17. A method of applying a security marking to a container wherein the security marking is formed on or attached to a plastics film, the said film secured to the exterior of the container.

18. A method according to claim 17, wherein the security marking is formed on a strip, a length of which is secured to the film.

19. A method according to either claim 17, wherein the film is cut from a continuous length or roll of film before or as it is applied to the container.

20. A method according to claim 17, wherein the security marking is applied to the film before or as the film is applied to the container.

21. (canceled)

22. (canceled)
